(19) United States
(12) Patent Application Publication
(10) Pub. No.: US 2011/0309213 A1
(43) Pub. Date: Dec. 22, 2011

(54) Device for Fine Adjustment of the Counterweight of a Telescopic Filming Crane

(76) Inventors: Alfredo Vallés Navarro, Cornella de Llobregat (Barcelona) (ES); Andrés Vallés Navarro, Cornella de Llobregat (Barcelona) (ES)

(21) Appl. No.: 13/148,509

(22) PCT Filed: Feb. 10, 2009
(86) PCT No.: PCT/ES2009/000074

§ 371 Date: Aug. 9, 2011

(51) Int. Cl. F16M 11/04

(52) U.S. Cl. 248/123.2

(57) ABSTRACT

Device for fine adjustment of the counterweight of a telescopic filming crane, such as the type of crane with telescopic mechanisms wherein unfolding and retraction thereof is compensated for by means of the displacement of counterweights with the aim of maintaining its equilibrium, comprising electronic means which control a movement transmission means (3) on a secondary counterweight platform (2) which regulate the position of the crane counterweight (1), ensuring more precise adjustment of the position of the crane counterweight (1) and its equilibrium in relation to the fulcrum thereof.

### FIELD OF THE INVENTION

The present invention develops a device for fine adjustment of the counterweight of a telescopic filming crane, such as the type of crane with telescopic mechanisms wherein unfolding and retraction thereof is compensated for by means of the displacement of counterweights with the aim of maintaining its balance, wherein by means of the generation of movement on an additional counterweight platform it is accomplished said precise adjustment of the balance in relation to the fulcrum of the telescopic crane.

### PRIOR ART

Extensible telescopic cranes for filming cranes and the stability problems caused by the cameras that are supported at the ends of their jibs are known, as are known the problems arising from the balance of the crane assembly that the camera mechanism, and sometimes the operator himself, are to withstand.

For instance, patent U.S. Pat. No. 4,907,768 describes a telescopic crane provided with a plurality of segments and at whose end is located a camera or filming head that is balanced during the ascent movements of the crane. In said document the telescopic segments of the crane are associated with the extension/retraction mechanism of a counterweight located at the rear portion thereof, such that while the jib of the crane is being extended the counterweight becomes extended as well in an inverse movement with the aim of maintaining the balance of the crane in relation to the fulcrum thereof.

However, all telescopic cranes pose a problem in respect of the fine or precise adjustment of their balance at some portion of their path or extension. Due to the movement of the masses and the fact that the counterweight carriage extends beyond the support center of the arm at some point of the path, it is not possible to keep the crane perfectly counterbalanced, which on most occasions entails vibration of the crane caused by its extension and lack of uniform balance.

In the prior art it is used a mechanic system for movement of the counterweight carriage so that the operator adjusts the critical point and thus leaves the crane off-balanced at the point deemed to be the least critical for its control. There is provided a small circular weight that slides along a rod which is manually-controlled by an operator in order to adjust the position of the crane weights at all times.

The above solution poses several drawbacks. On the one hand, it is inconvenient for the operator to control the crane weights even when it has to hold greater weights. As a result of the above it turns out to be extremely difficult to accomplish proper initial and final crane movements. The operator is more likely to end up paying more attention to controlling crane weights than controlling crane movement.

Additionally, whenever the crane stops at a critical point there exist oscillations in the position of the crane arm caused by the operator having to counteract weight difference with his own effort.

Lastly, it is desirable an automatic means for effecting the balancing of the crane, thereby freeing the operator from such task.

The object of the present invention is to overcome said difficulties by providing a fine additional adjustment of the crane counterweight.

This and other advantages of the present invention will become more apparent throughout the appended description thereof.

### BRIEF DESCRIPTION OF THE INVENTION

The present invention describes a device for fine adjustment of the counterweight of a telescopic filming crane, such as the type of crane with telescopic mechanisms wherein unfolding and retraction thereof is compensated for by means of the displacement of counterweights with the aims of maintaining its balance, wherein by means of the generation of movement on an additional counterweight platform it is accomplished said precise adjustment of the balance in relation to the fulcrum of the telescopic crane.

The device of the invention thus includes a secondary counterweight platform, counterweights, a mechanic system for transmitting movement, a primary counterweight platform, a motor for actuating the mechanic system and several tubes and joints in the device.

By means of the above construction all the sought inventive objects are accomplished. For instance, through the automatic mechanism for displacement of the counterweight of the fine adjustment it is avoided the operator's tedious task of balancing the crane upon extension of the telescopic arm thereof. Additionally, accomplishing said balance in a more efficient manner results in a balancing of the crane movements thereby avoiding oscillations and shaking thereof.

### BRIEF DESCRIPTION OF THE DRAWINGS

For a better understanding of the invention it is accompanied by two sheets of merely illustrative and non-limiting drawings.

FIG. 1 illustrates a schematic view of a transverse section of the telescopic arms of the crane and the fine adjustment mechanism according to the preferred embodiment of the invention.

FIGS. 2 and 3 respectively illustrate two extreme occurrences of displacement caused by the action of the fine adjustment of the present invention, like in the embodiment of FIG. 1.

FIGS. 4 to 6 illustrate different occurrences of displacement of the fine counterweight adjustment of the present invention in another possible embodiment thereof, wherein the secondary platform is associated with the first tube.

### DETAILED EXPLANATION OF THE INVENTION

The present invention comprises a device for fine adjustment of the counterweight of a telescopic filming crane, such as the type of crane with telescopic mechanisms wherein unfolding and retraction thereof is compensated for by means of the displacement of counterweights with the aims of maintaining its balance, wherein by means of the generation of movement on an additional counterweight (1) platform (2) it is accomplished said precise adjustment of the balance in relation to the fulcrum of the telescopic crane.

The first tube or first telescopic arm (8) extending from the main tube (5) is coupled thereto by means of a joint (4) in accordance with any of the known means in the art.

According to the known art, the displacement of the first tube (8) in relation to the main tube (5), since there occurs the extension or retraction of the telescopic mechanism of the crane, involves a displacement of the counterweight (1) relative to said main tube (5).

According to the present invention, on a secondary counterweight platform (2) is attached a system for the transmission of movement (3) actuated by a motor (7). The invention is provided with electronic means for controlling, by acting on said motor (7), the movement of said means for transmitting movement (3) of said platform (2). Said means for transmitting movement (3) can be, for example, a stud, that displaces in a fine fashion the crane counterweight (1) in an additional adjusting movement of the overall movement of the known counterweight (1).

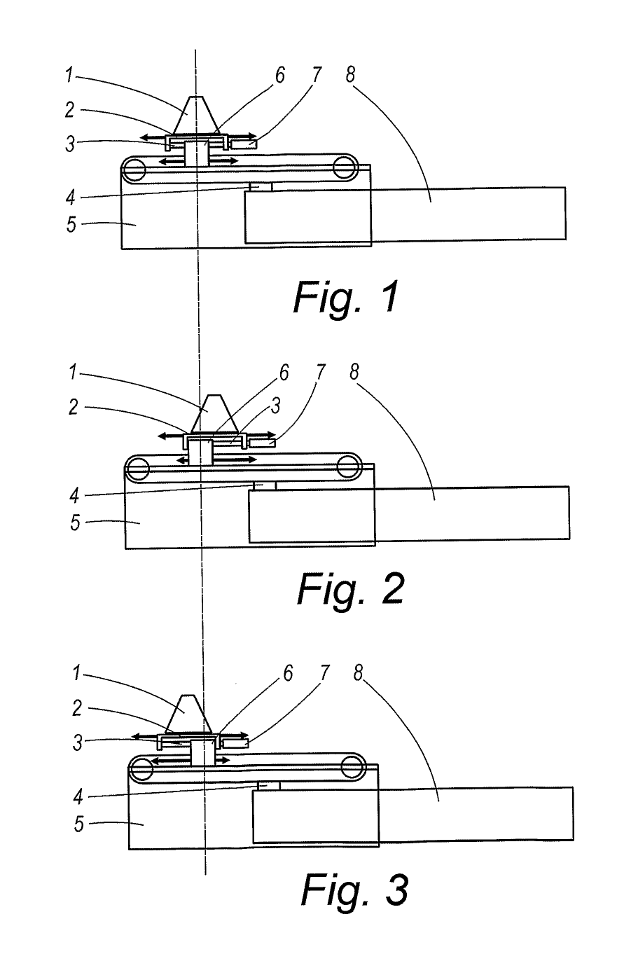

In the first possible embodiment of the invention, illustrated in FIGS. 1 to 3, such secondary counterweight platform (2) is positioned along the main tube (5) by the primary counterweight platform (6). The primary counterweight platform (6), as indicated above, moves relative to the movement of the tube or first telescopic arm (8).

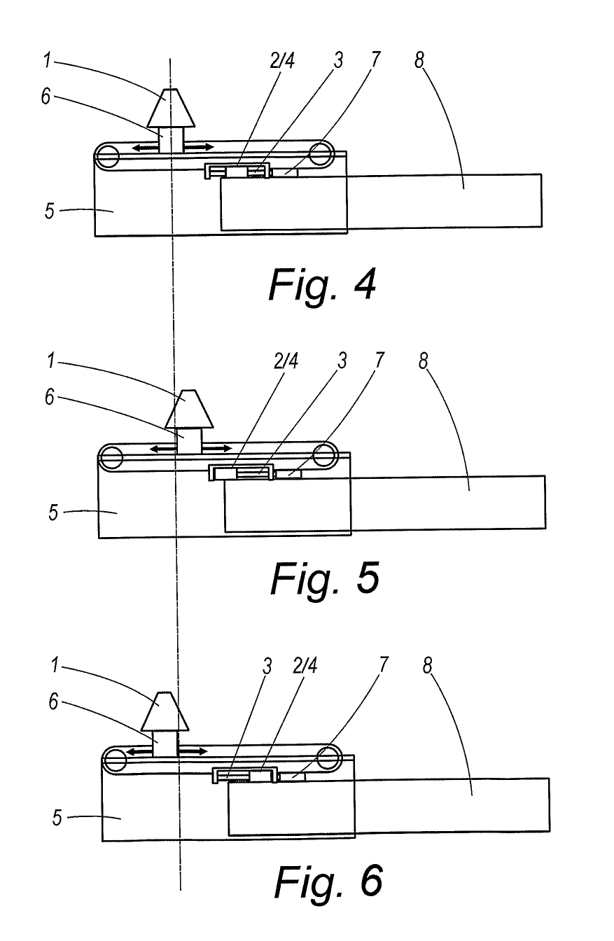

In another possible embodiment of the invention, as illustrated in FIGS. 4 to 6, said secondary counterweight platform (2) is associated with first tube (8). Broadly speaking, the functioning of the fine adjustment is similar in both embodiments.

During actual functioning, the device of the present invention, in each of its embodiments, requires a prior calibration operation based on the weight that the crane jib has to withstand and likewise adapted to the specific configuration of the features of each particular telescopic crane.

Such calibration process involves that for every starting point of the first tube (8) the operator marks a point of placement for the secondary counterweight platform (2) so as to provide the perfect counterweight to the difference of masses during the path. These displacement correspondences of the first tube (8) with a position of the counterweight platform (2) are stored in the control means of the device.

Once all the adjustments points are marked, it is actuated a function that has been pre-programmed in the control mechanisms of the device of the type “generator of movement of the secondary platform” and, automatically, the secondary counterweight platform (2) starts moving regardless of the path of the first tube (8), although always depending on said path, thereby it thus permitting and performing the automatic fine adjustment at all the path points of the crane according to the main goal of the present invention.

Actually, the process for calibrating the device is factory-supplied, so that the device of the invention can be delivered once calibrated to the user. Such factory-supplied calibration is accomplished through automatic means based on the manufacturing patterns of each production process. It may be necessary, on occasion, for the user to perform a further adjustment by using the above-described point per point calibration. Users always have the possibility of modifying the adjustments, recovering the factory-supplied adjustments, etc.

It is understood that finish or shape details in the present case are liable to variation provided that the essence of the invention is not altered.

1-8. (canceled)

9. A device for fine adjustment of the counterweight of a telescopic filming crane, such as the type of crane with telescopic mechanisms wherein unfolding and retraction thereof is compensated for by means of the displacement of counterweights with the aims of maintaining its balance, comprising electronic means for controlling a means for transmitting movement on a secondary counterweight platform, for acting on the position of the crane counterweight and for accomplishing the fine adjustment of the position of said counterweight and the fine balance of the crane in relation to the fulcrum thereof for different extension positions of the first tube in relation to the main tube.

10. A device for fine adjustment of the counterweight of a telescopic filming crane, according to claim 1, wherein said means for transmitting movement is effected through any known method, for example, a stud.

11. A device for fine adjustment of the counterweight of a telescopic filming crane, according to claim 1, further comprising adequate storing means for preserving a plurality of pairs of positions of calibration of the device, wherein each starting point of said first tube relative to said main tube corresponds with a positioning point of said secondary counterweigh platform that permits the perfect balance of the crane fulcrum.

12. A device for fine adjustment of the counterweight of a telescopic filming crane, according to claim 1, wherein said displacement correspondences of said first tube with a position of said secondary counterweight platform are stored by the control means of the device.

13. A device for fine adjustment of the counterweight of a telescopic filming crane, according to claim 1, wherein said device, once calibrated, can, following the instructions of said control mechanisms thereof, automatically move said secondary counterweight platform depending on the path of the first tube through a movement intended to perform the automatic fine adjustment at each and every path point of the crane.

14. A device for fine adjustment of the counterweight of a telescopic filming crane, according to claim 1, wherein the first tube extending from the main tube is attached thereto through a joint according to any of the known means of the art.

15. A device for fine adjustment of the counterweight of a telescopic filming crane, according to claim 1, wherein said secondary counterweight platform is positioned at said main tube by the primary counterweight platform.

16. A device for fine adjustment of the counterweight of a telescopic filming crane, according to claim 1, wherein said secondary counterweight platform is positioned at said primary tube.
